(19) United States
(12) Patent Application Publication
(10) Pub. No.: US 2005/0010812 A1
(43) Pub. Date: Jan. 13, 2005

(54) Computer system software "black box" capture device

(75) Inventors: William Lee Terrell, Austin, TX (US); Steven A. Bade, Georgetown, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/464,886

(22) Filed: Jun. 19, 2003

(51) Int. Cl. H04L 9/00

(52) U.S. Cl. 713/201

(57) ABSTRACT

A method and apparatus for automatically collecting, combining, and storing operating system environment information in a trusted location on the data processing system to provide a persistent store record of all operating system events leading up to the detection of a problem. The software for the ‘black box’ device is a combination of existing system software and logging capability with the added ‘black box’ specific software functions required to generate, time-stamp, cryptographically sign and log events to the secure logging device. Operating system environment information is collected, entered into a log, and stored in a trusted location on the system. The information in this log may be used to analyze system crashes caused by security breaches. Determinations can be made from the log if the system was at correct security software ‘patch’ level or if network services were incorrectly configured or enabled.

### BACKGROUND OF THE INVENTION

1. Technical Field

The present invention is directed towards an improved computing system. More particularly, the present invention relates to a method and apparatus for automatically collecting and recording information for use in causal analysis of system crashes caused by security breaches.

2. Description of Related Art

Software security is rapidly becoming one of the most significant issues facing the computer industry today. New attacks designed to disrupt and inflict damage to business systems are being developed every day. Significant exploits of existing attacks also serve to reduce the confidence in and the integrity of computer products. Security is increasingly important for software vendors, because current trends indicate that they may face legal (and financial) liability in the future for damages resulting from a security flaw in their software. Monitoring the system to determine whether or not an available software upgrade and/or fix was applied to a system prior to a security breach may become critical to vendors seeking to protect themselves against neglectful system administrators or owners.

Many industries currently employ ‘black box’ type devices that collect physical information about the environment at the time an event occurs. For example, aircraft black boxes have proven highly successful in allowing the recreation of accident scenarios and have led to significant safety improvements in the aircraft fleet. In the automotive industry, General Motors (GM) offers similar capabilities to the automotive public by using its OnStar GPS system to call emergency personnel in the event of a detected impact. The GM system employs sensors to include information in the call such as the location of the vehicle, the number of passengers, and the state of the vehicle.

It would be desirable to use existing software components in a unique combination to form a ‘black box’ software capture device to monitor the state of the system after an event, such as a software upgrade or fix, has been performed. The ‘black box’ software capture device would provide similar functionality of black boxes in other fields. Sensors may be utilized throughout the operating system environment to collect and record information regarding the state of the system. Sensors can be used, as part of an intrusion detection system (IDS), to detect system attacks. Sensors (or software agents) can also be used to detect and manage software inventory (i.e., keep track of updates and fixes to the system). In remote sensing management, sensors are utilized for ‘sensing’ the ‘settings’ of system and network services (i.e., network protocols and ports in use). As more and more security features and hooks are being added, operating systems are regularly receiving more sensor intelligence.

Service personnel conventionally use sensors to take ‘snapshots’ of the state of the system for troubleshooting purposes and save the information. However, these conventional methods are usually manually invoked and the information resulting from invoking the utilities is often short-lived non-persistent, not correlated with other system reports. In the security context, there needs to be more than just a moment-in-time still picture. It would be desirable to have, as in the case with aircraft black boxes, a persistent store record of the events leading up to the detection of a problem.

Consequently, there exists a need to allow software vendors to collect forensic information about the state of the application or system. Not only can this information assist vendors in making improvement to the system, but this information is also critical to protect a vendor from legal liability by providing proof that a vendor has complied with the obligations of maintaining a system by supplying updates and patches to users. For example, if a system has a flaw that allowed the system to be successfully penetrated by an attack and the vendor had previously made a fix available for that flaw, information in the ‘black box’ can assist the vendor in showing that it was an inactive and neglectful user who failed to apply the necessary fix to the system, and not the software fix itself that resulted in the damage to the system. As a result, collection of software updates/fix levels and security settings becomes paramount in both allowing for improvement of the software, as well as providing the information needed in the event of litigation.

Thus, it would be beneficial to have a method and system for automatically collecting, combining, and storing operating system environment information in a trusted location on the system to provide a persistent store record of all operating system events leading up to the detection of a problem. It would further be beneficial to store the operating system environment information in a manner such that the information can be proven to be original, or tamper-free.

### SUMMARY OF THE INVENTION

The present invention overcomes the limitations and disadvantages of the prior art systems by combining known software components to form a unique software security capture device. The present invention provides a method and system for automatically collecting, combining, and storing operating system environment information in a trusted location on the system to provide a persistent store record of all operating system events leading up to the detection of a problem. This invention proposes automatically capturing the time-stamped ‘security state’ of the system. The captured information is entered into a log and stored in a trusted location on the system. The information in this log may be used for analyzing system crashes caused by security breaches. Determinations could be made from the log if the system was at correct security software ‘patch’ level or if network services were incorrectly configured or enabled.

Implementation of these components of this solution is in a combination of hardware and software. The software for the ‘black box’ device is a combination of existing system software and logging capability with the added ‘black box’ specific software functions required to generate, time-stamp, cryptographically sign and log events to the secure logging device.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing system in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram showing a computer system software capture device in accordance with the present invention; and

FIG. 5 is a flowchart illustrating a process in the logical design in accordance with the present invention.

### DETAILED DESCRIPTION OF THE PREFERRED EMBODIMENT

The present invention provides an automated method and apparatus for automatically collecting, combining, and storing operating system environment information in a trusted location on the system to provide a persistent store record of all operating system events leading up to the detection of a problem. This invention automatically capturing the time-stamped ‘security state’ of the system. The illustrative embodiments of the present invention are best understood by referring to the figures, wherein corresponding reference numerals are used to represent corresponding elements of all figures unless otherwise indicated.

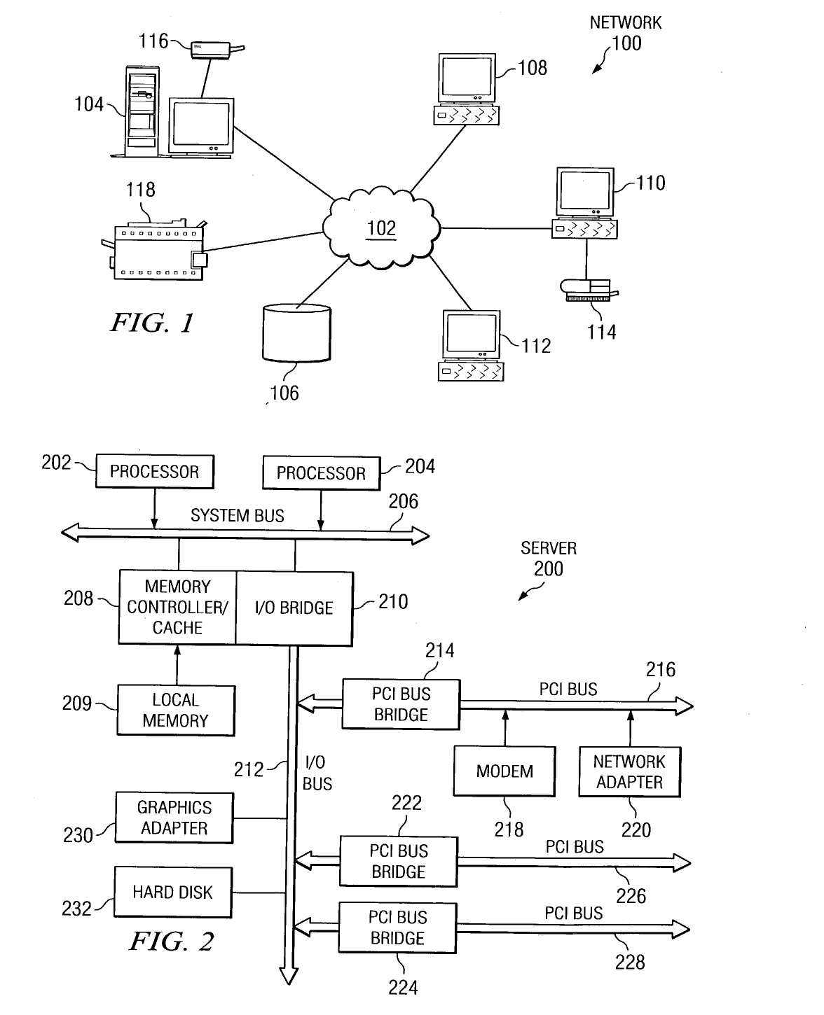

FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 includes printers 114, 116, and 118, and may also include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, N.Y., running the Advanced Interactive Executive (AIX) or Linux operating systems.

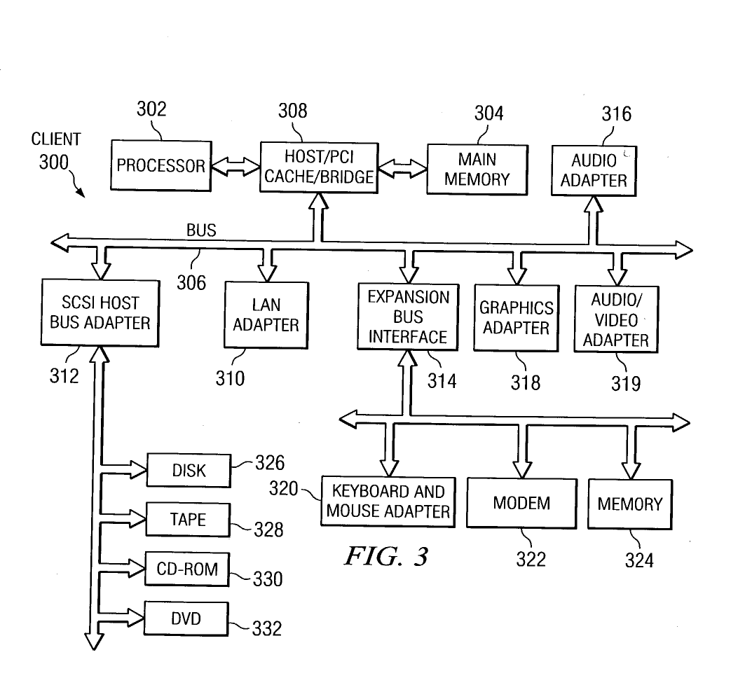

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned previously, the present invention involves automatically collecting information regarding the state of the application or system. Although the individual components used in the present invention may be conventional devices, the combination of the components to form a system software capture device is unique and original for the applicable software environment. The present invention creates a persistent store record of events leading up to the detection of a problem in the system. An ‘event’ includes updates or fixes to the system software. Installation of the software updates/fixes triggers the ‘black box’ capture process of the present invention.

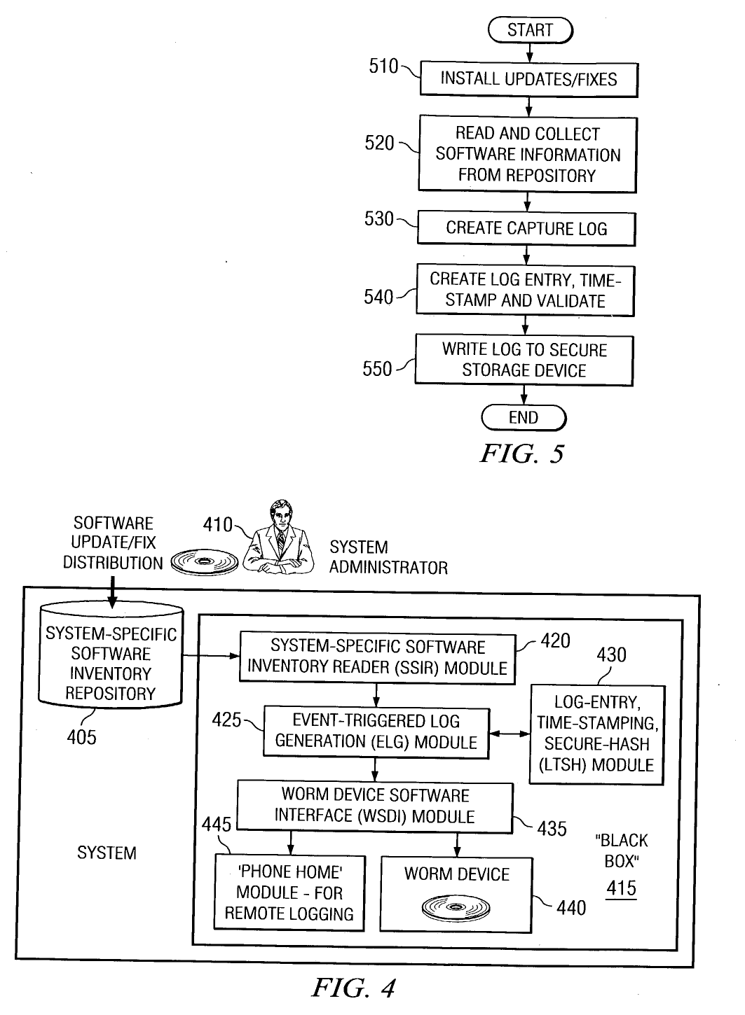

FIG. 4 shows the overall architecture of computer security software capture system 415 according to one embodiment of the present invention. As is known, update version information can be stored in software inventory repository 405 in order to retain a record of all updates and fixes that have been performed on the system. Since the present invention designates the upgrade/fix installation process as an ‘event’, the present invention not only retains information on all upgrades/fixes that have been performed on the system, but it also provides a mechanism to create a running log of the state of the system after an event occurs.

When system administrator 410 installs the system-specific software updates or fixes, the update version information is written to local system-specific software inventory repository 405 and stored. System-specific software inventory repository, as known in the art, is used to retain a record of all updates and fixes that have been performed on the system. In the depicted example, ‘black box’ capture device 415 includes System-specific Software Inventory Reader (SSIR) module 420, Event-triggered Log Generation (ELG) software module 425, Log-entry, Time-stamping, Secure-Hash (LTSH) software module 430, and WORM Device Software Interface (WDSI) module 435. System-specific Software Inventory Reader module 420 reads and collects the software update information contained in software inventory repository 405. The actual process of collecting the software update information from software inventory repository 405 may take different forms depending on the system.

System-specific Software Inventory Reader module 420 passes the event information to Event-triggered Log Generation module 425. In response, Event-triggered Log Generation module 425 creates a capture log in which to store information regarding an event. The event information is passed from ELG module to Log-entry, Time-stamping, Secure-Hash (LTSH) module 430. LTSH module 430 generates a time-stamp for the event and enters the time-stamp into the log entry for the event. Sensors (not shown) are used to capture the time-stamped state of the system when the event occurred. Additionally, LTSH module 430 verifies and signs the log entry by cryptographically hashing the event information. Thus, the present invention guarantees that the log entry is valid and tamper-free.

Once the log entry has been verified and signed, LTSH module 430 passes the log entry to WORM Device Software Interface module 435. WORM Device Software Interface module 435 writes the log to WORM device 440. Hardware component WORM device 440 takes the form of the (6) Secure Logging Device (SLD), a write-once, protected logging device, such as a write-once, read multiple (WORM) CD drive, hereafter referred to as ‘WORM device’ 440. Thus, WORM device 440 maintains a running ‘capture log’ of the patch/update activity on the system being monitored.

Although FIG. 4 is depicted as using a WORM device, other devices also may be used to store the log without departing from the spirit of the present invention. Possible devices include, but are not limited to, a dedicated region of a hard disk under direct operating system control or a compact flash device within the system.

FIG. 4 also shows a remote logging or ‘Phone Home’ (PH) module 445. Remote logging module 445 can be used in large-scale distributed environments to report the state of the particular system to a central manager.

FIG. 5 is a flowchart outlining an exemplary operation of the present invention. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

As shown in FIG. 5, the software capture process begins with installing software updates/fixes to the system (step 510). The installation results in the updates/fixes being written to the software inventory repository. It is fundamentally the installation of the updated software or fixes, via system-specific commands or utilities, that also triggers the creation and logging by the present invention of events to the WORM device. The System-specific Software Inventory Reader module reads and collects the software state information in the repository (step 520). The System-specific Software Inventory Reader module then converts the software update information into a common data format consumable by the Event-triggered Log Generation module Event-triggered Log Generation module generates a ‘black box’ log (step 530) in which to store information regarding the event. The event information is passed from the ELG module to the Log-entry, Time-stamping, Secure-Hash module, which generates a time-stamp for the event and enters the time-stamp into the log (step 540). Sensors located throughout the system are used to capture the time-stamped state of the system when the event occurred. Additionally, the LTSH module verifies and signs the log entry by cryptographically hashing the event information (step 540). Thus, the present invention guarantees that the log entry is valid and tamper-free.

The Worm Device Software Interface module receives the log entry from the LTSH module and writes the log to the WORM device (step 550). The WORM device maintains a running ‘capture log’ of the patch/update activity on the system being monitored.

Thus, the present invention provides an apparatus and method for automatically creating a persistent store record of events leading up to the detection of a problem in the system. The advantages of the present invention should be apparent in view of the detailed description provided above. One can take a ‘snapshot’ to locate a problem within a system. However, such prior methods usually require the utility to be manually invoked, and the information gathered from invoking the utility is often short-lived or correlated with other system reports. In contrast, the present invention not only is an automated process that creates a running log of the state of the system after an event occurs, but it also records events showing if the system administrator or owner properly applied software upgrades and/or fixes necessary for protecting the system.

The present invention also provides the advantage of storing the information in a manner such that the contents can be proven to be original and unaltered (for example, aviation black boxes are built to withstand severe trauma and still retain the integrity of the data).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method of capturing software state information in an operating system environment to create a persistent running record of the software state, comprising:
installing at least one software update to a data processing system;
storing a record of the installation of the at least one update to the data processing system in a software inventory repository;
collecting the at least one update information from the repository and creating a capture log in response to installing the at least one software update to the data processing system;
generating a log entry in the capture log comprising information relating to the at least one software update to the data processing system; and
storing the capture log in a storage device.

2. The method of claim 1, further comprising:
verifying and signing the log entry.

3. The method of claim 1 wherein retrieving the at least one software update information from the repository in response to installing the at least one software update to the data processing system includes converting the at least one software update into a common data format.

4. The method of claim 1 wherein generating a log entry in the capture log comprising of information relating to the at least one software update to the data processing system includes time stamp information.

5. The method of claim 2 wherein verifying the log entry includes cryptographically hashing the information relating to the at least one software update to the data processing system.

6. The method of claim 1 wherein the storage device is a WORM device.

7. A system for capturing software state information in an operating system environment, the system comprising:
a software inventory repository for storing software update information;
a software inventory reader for collecting software update information from the software inventory repository in response to a software update installation;
an event-triggered log generation device for creating a capture log in response to the software update installation; and
a storage device for storing the capture log.

8. The system of claim 7 wherein the software inventory reader converts the software update information into a common data format.

9. The system of claim 7 wherein the capture log comprises an entry including time stamp information related to the software update installation.

10. The system of claim 7 wherein the software update installation information is verified.

11. The system of claim 10 wherein the verification step is performed by cryptographically hashing the software update installation information.

12. The system of claim 7 wherein the storage device is a WORM device.

13. A computer program product in a computer readable medium for capturing software state information in an operating system environment, comprising:
first instructions for installing at least one software update to a data processing system;
second instructions for storing a record of the installation of the at least one software update to the data processing system in a software inventory repository;
third instructions for collecting the at least one software update information from the repository and creating a capture log in response to installing the at least one software update to the data processing system;
fourth instructions for generating a log entry in the capture log comprising of information relating to the at least one software update to the data processing system; and
fifth instructions for storing the capture log in a storage device.

14. The computer program product of claim 13, further comprising:
sixth instructions for verifying and signing the log entry.

15. The computer program product of claim 13 wherein retrieving the at least one software update information from the repository in response to installing the at least one software update to the data processing system includes converting the at least one software update into a common data format.

16. The computer program product of claim 13 wherein generating a log entry in the capture log comprising of information relating to the at least one software update to the data processing system includes time stamp information.

17. The computer program product of claim 14 wherein verifying the log entry includes cryptographically hashing the information relating to the at least one software update to the data processing system.

18. The computer program product of claim 13 wherein the storage device is a WORM device.

19. A data processing system for capturing software state information in an operating system environment, comprising:
means for installing at least one software update to the data processing system;
means for storing a record of the installation of the at least one software update to the data processing system in a software inventory repository;
means for collecting the at least one software update information from the repository and creating a capture log in response to installing the at least one software update to the data processing system;
means for generating a log entry in the capture log comprising of information relating to the at least one software update to the data processing system; and
means for storing the capture log in a storage device.

20. The data processing system of claim 19, further comprising:
means for verifying and signing the log entry.

21. The data processing system of claim 19 wherein generating a log entry in the capture log comprising of information relating to the at least one software update to the data processing system includes time stamp information.

22. The data processing system of claim 20 wherein verifying the log entry includes cryptographically hashing the information relating to the at least one software update to the data processing system.

23. The data processing system of claim 19 wherein the storage device is a WORM device.

24. A method of capturing software state information in an operating system environment to create a persistent running record of the software state, comprising:
installing at least one software update to a data processing system;
storing a record of the installation of the at least one software update to the data processing system in a software inventory repository;
retrieving the at least one software update information from the repository in response to installing the at least one software update to the data processing system;
generating a log in response to installing the at least one software update to the data processing system;
capturing a time-stamped software state of the system in relation to the time the at least one software update occurred;
writing the time-stamped software state information to the log;
verifying the log entry by cryptographically hashing the event information;
sending the log to a storage device; and
storing the log in the storage device.
